(19) United States
(12) Patent Application Publication
(10) Pub. No.: US 2018/0337559 A1
(43) Pub. Date: Nov. 22, 2018

(54) POWER LIMITING IN A WIRELESS POWER TRANSMITTER

(71) Applicant: Integrated Device Technology, Inc., San Jose, CA (US)

(72) Inventors: Nicholaus Wayne SMITH, La Mesa, CA (US); Feng ZHOU, San Jose, CA (US); Thomas Joseph DeLURIO, San Jose, CA (US)

(21) Appl. No.: 15/982,870

(22) Filed: May 17, 2018

Related U.S. Application Data
(60) Provisional application No. 62/508,220, filed on May 18, 2017.

(51) Int. Cl. H02J 50/12; H02J 50/05; H02J 7/02

(52) U.S. Cl. CPC H02J 50/12; H02J 7/025; H02J 50/05

(57) ABSTRACT

In accordance with some embodiments of the present invention, a method of reducing transmitted power in a wireless power transmitter is presented. In some embodiments, the method and circuits reduce a resonance power level in a tank circuit coupled to a transmitter in the wireless power transmitter while not increasing an operating frequency above a frequency limit.

### RELATED APPLICATIONS

This application claims priority to U.S. Provisional Application Ser. No. 62/508,220, filed on May 18, 2017, which is herein incorporated by reference in its entirety.

### TECHNICAL FIELD

Embodiments of the present invention are related to wireless power systems and, specifically, to power limiting in a wireless-power transmitter.

### DISCUSSION OF RELATED ART

Typically, a wireless power system includes a transmitter coil that is driven to produce a time-varying magnetic field and a receiver coil that is positioned relative to the transmitter coil to receive the power transmitted in the time-varying magnetic field. Of the issues that arise with wireless power transmission is the need to control the transmitted power while adjusting the frequency output.

However, issues arise when a receiver requests a power reduction when the transmitter is operating close to a frequency limit. Previously, this issue has been handled by dithering and tuning the dithering frequency changes with corresponding duty cycle changes to match the power changes caused by frequency dithering. However, this technique causes some delays due to necessary tuning and some output voltage instability due to the dithering compensation not being perfectly tuned.

Therefore, there is a need to develop systems that help control power and frequency output of a wireless power transmitter

### SUMMARY

In accordance with some embodiments of the present invention, a method of reducing transmitted power in a wireless power transmitter is presented. In some embodiments, the method and circuits reduce a resonance power level in a tank circuit coupled to a transmitter in the wireless power transmitter. In some embodiments, the power can be limited while not increasing an operating frequency of a frequency limit.

These and other embodiments are further discussed below with respect to the following figures.

### BRIEF DESCRIPTION OF THE DRAWINGS

FIG. 1 illustrates a wireless power transmission system.

FIG. 2 illustrates the transmitter coil positioned on a printed circuit board of a transmitter.

FIG. 3 illustrates an example embodiment of a transmission system according to the present invention.

FIG. 4A shows another example of an embodiment similar to that shown in FIG. 3.

FIGS. 4B, and 4C illustrate results from an example of the embodiment illustrated in FIG. 4A.

FIG. 5 illustrates use of a buck regulator according to some embodiments of the present invention.

FIG. 6 illustrates shifting a resonance according to some embodiments of the present invention.

FIG. 7 illustrates a pulse skip circuit according to some embodiments of the present invention.

FIG. 8 illustrates a programmable load according to some embodiments of the present invention.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

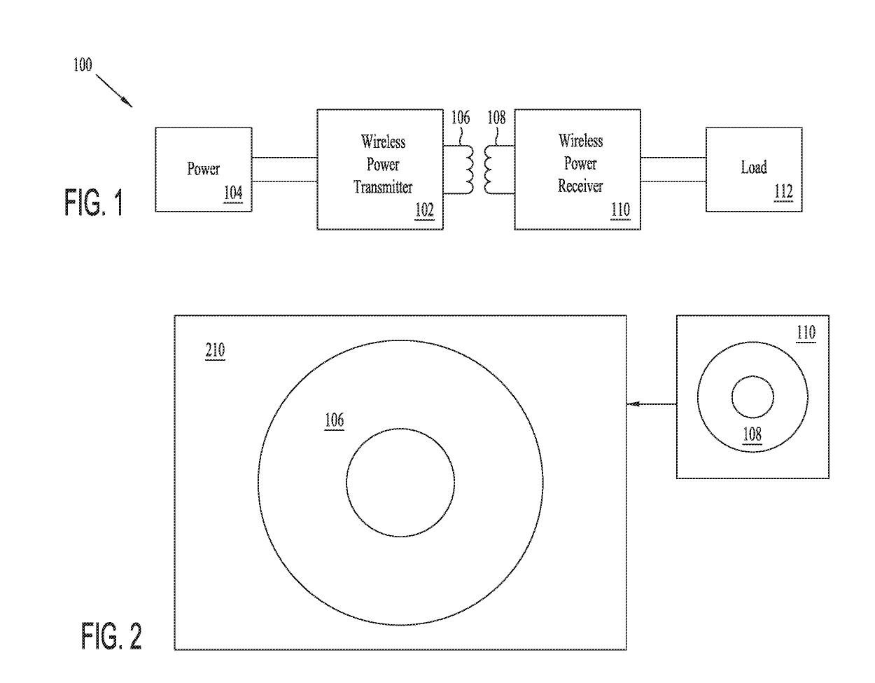

The figures are illustrative only and relative sizes of elements in the figures have no significance. For example, although in FIG. 2 receiver coil 108 is illustrated as smaller than transmitter coil 106, receiver coil 108 may be the same size as transmitter coil 106 or may be smaller, or larger depending on particular systems.

FIG. 1 illustrates a system 100 for wireless transfer of power. As illustrated in FIG. 1, a wireless power transmitter 102 drives a coil 106 to produce a magnetic field. A power supply 104 provides power to wireless power transmitter 102. Power supply 104 can be, for example, a battery based supply or may be powered by alternating current for example 120V at 60 Hz. Wireless power transmitter 102 drives coil 106 at, typically, a range of frequencies, typically according to one of the wireless power standards. However, this could be applicable to any frequency where it is practical to transfer power and/or information by means of magnetic coils irrespective of any standard that may exist.

There are multiple standards for wireless transmission of power, including the Alliance for Wireless Power (A4WP Currently known as Airfuel) standard and the Wireless Power Consortium standard, the Qi Standard. Under the A4WP standard, for example, up to 50 watts of power can be inductively transmitted to multiple charging devices in the vicinity of coil 106 at a power transmission frequency of around 6.78 MHz. Under the Wireless Power Consortium, the Qi specification, a resonant inductive coupling system is utilized to charge a single device or near at the resonance frequency of the device. In the Qi standard, coil 108 is placed in close proximity with coil 106 while in the A4WP standard, coil 108 is placed near coil 106 along with other coils that belong to other charging devices. FIG. 1 depicts a generalized wireless power system 100 that operates under any of these standards. In Europe, the switching frequency has been limited to 148 kHz.

As is further illustrated in FIG. 1, the magnetic field produced by coil 106 induces a current in coil 108, which results in power being received in a receiver 110. Receiver 110 receives the power from coil 108 and provides power to a load 112, which may be a battery charger and/or other components of a mobile device. Receiver 110 typically includes rectification to convert the received AC power to DC power for load 112.

In some embodiments, during wireless power transfer when the upper operating frequency limit is reached and duty cycle power limiting method is employed, conducted and radiated emissions have been observed. It has been found that the primary cause of the conducted emission is common mode voltage changes on the surface of the TX coil and the power receiving device, which form opposite plates of a parasitic capacitance. The inherent capacitance of the charging device to Earth's surface forms a current path that is causing current flow that is capacitively coupled (via a time-varying E-field) from the Tx coil to the phone to the Earth, which can detected by an EMI measurement unit.

The European Union has a switching frequency limit of 148 kHz. Some embodiments of the present invention allow for the reduction of transmitted power and combine frequency range adjustments and other forms of power limiting other than duty cycle decreases when less power is requested and the frequency limit, in Europe of 148 kHz, for example, has been reached. While achieving this goal, the resulting transmitter should comply with the wireless power consortium (WPC) or other applicable standards. Further, the power should be limited without operating above a frequency limit, such as 148 kHz in Europe. Additionally, any electromotive interference (EMI) requirements should be met. Also, the functional impact (e.g. efficiency, disconnects, cost) should be minimized. Additionally, special work-arounds or tuning (for example dithering) should be avoided.

Consequently, embodiments of the present invention may control the power in one or more of several ways. These ways include the following: 1) The addition of conductive shielding; 2) Addition of a buck-boost to regulate power to the bridge voltage; 3) Alteration of the tank resonance; 4) Addition of pulse skipping to reduce power; or 5) Addition of a load to the transmitter LC node that consumes power.

### 1. Addition of Conductive Shielding

As further disclosed in U.S. patent application Ser. No. 15/793,797, filed by Alfredo Saab and David Wilson on Oct. 25, 2017, which is herein incorporated by reference in its entirety, conductive shielding may be placed over the wireless transmitter power delivery coil. This feature may reduce EMI. In particular, the metallic shield uses topological techniques that minimize the impact on the power delivery magnetic fields while maximally attenuating electric and/or electromagnetic emissions. The core concepts leverage firstly that the propagation of magnetic fields is quite different from the propagation of electromagnetic fields, and further, can make use of the fact that the wavelength of the magnetic field in some cases is substantially longer than that of the electromagnetic waves of concern for reduction of EMI. These features may be implemented without affecting standard WPC compliance (allow normal operation of variable frequency transmit coils, for example with Qi A11, A6, or A28 type coils) and alleviate the need for dithering and other special workarounds.

FIG. 2 illustrates an example of a transmission coil 106 mounted in a pad 210. In some embodiments, transmission coil 106 is mounted on a printed circuit board (PCB), which is not illustrated in FIG. 2. FIG. 2 additionally illustrates a receiver coil 108 mounted in a receiving device 110 being brought into proximity to transmission coil 106. As discussed above, embodiments of the present invention reduce or substantially eliminate the capacitive coupling of the electromagnetic fields between transmission coil 106 and receiving device 110, thereby reducing EMI, while not substantially interfering with the magnetic transmission of wireless power between transmission coil 106 and receiver coil 108.

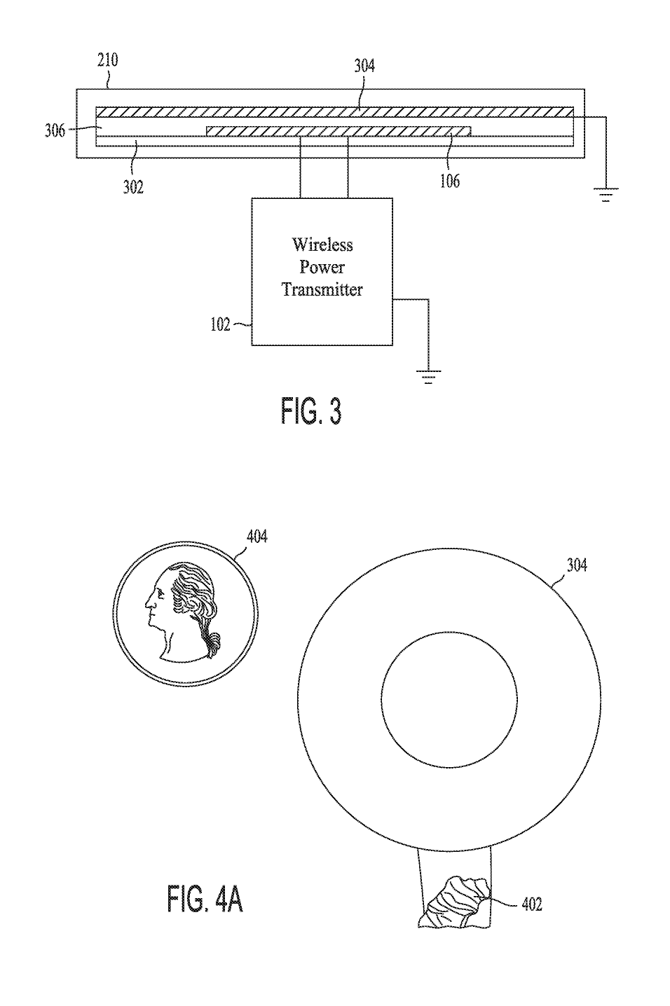

FIG. 3 illustrates a wireless transmitter according to some embodiments of the present invention. As shown in FIG. 3, transmission coil 106 may be embedded in a pad 210. In some embodiments, transmission coil 106 can be mounted on a printed circuit board (PCB) 302. In accordance with some embodiments of the present invention, a conductive sheet 304 is mounted over transmission coil 106 in some cases may be separated from transmission coil 106 by an insulation or spacer layer 306 on PCB 302. In some embodiments, conductive sheet 304 can be coupled to the ground of wireless power transmitter 102, as is illustrated in FIG. 3.

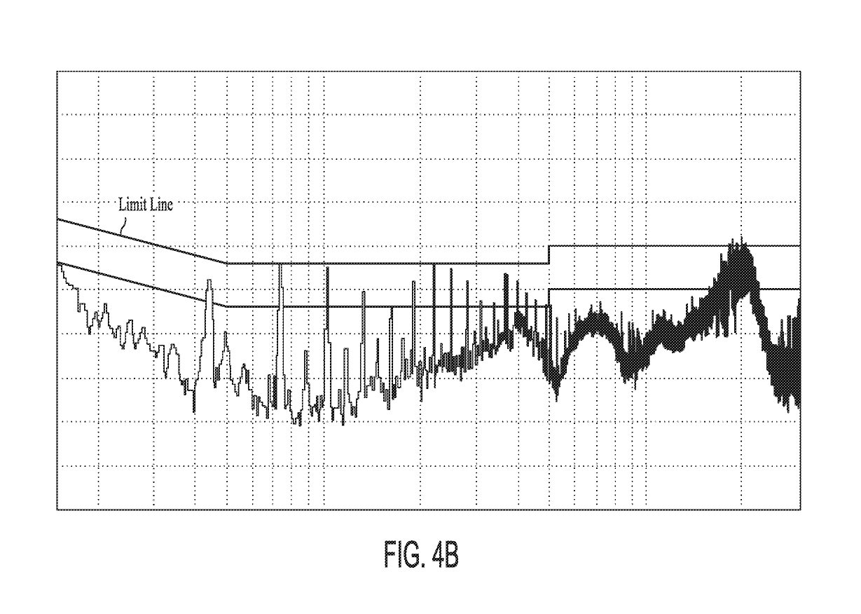

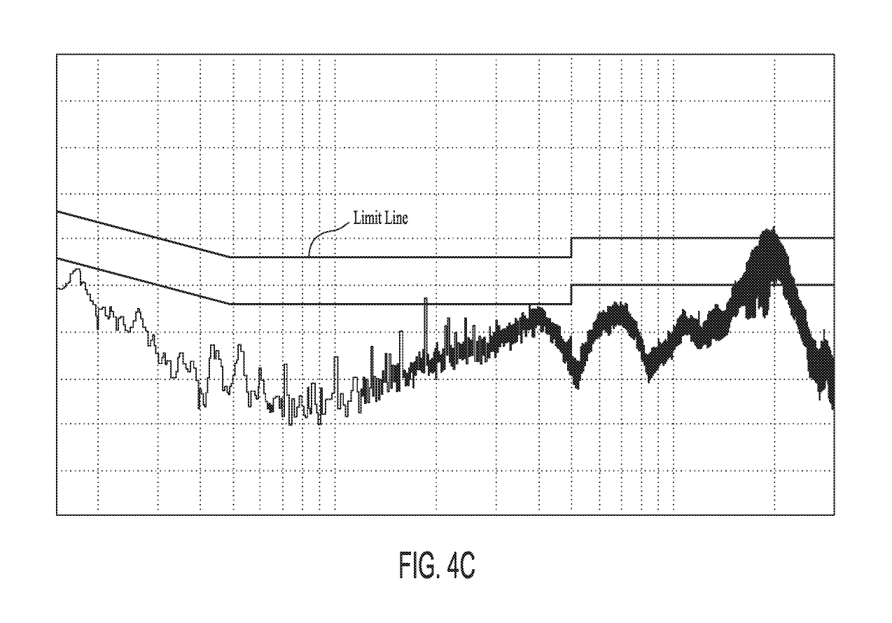

FIG. 4A illustrates an example of a conductive sheet 304 that can be placed over a transmission coil 106 as illustrated in FIG. 3. A ground strap 402 can be used to ground conductive sheet 304. In some embodiments, conductive sheet 304 can form a conductive film slotted ring filter with a one point ground connection. An example material that can be used is 3M KAPTON 200RS100, 2 mil thick, which has a sheet resistivity of 100 Ω/sq. For size comparison, coil 106 is placed next to a quarter 404.

FIG. 4B illustrates power output of a transmitter coil 106 without conductive sheet 304 as illustrated in FIG. 4A. FIG. 4C illustrates the power output of a transmitter coil with conductive sheet 304 as illustrated in FIG. 4A. As illustrated, the number of noise spikes is much reduced with conductive sheet 304 in place. Also observed is that the limit line is no longer breached except to the far right of the curve, which is not related to wireless charger but instead to phone communications, after adding the conductive shielding. Furthermore, the margin line (black line below the limit line), which is used to provide adequate tolerance to the passing result such that all production units will meet the requirement, is also no longer breached by the majority of the harmonics as was the case prior to adding the shield; showing the reduction in magnitude (power) of the EMI radiation that the shield offers.

Consequently, with the shielding, standard power reduction techniques can be used while protecting against EMI and other effects produced by those techniques.

### 2. Addition of a Buck Regulator

A Buck regulator can be used to reduce the bridge voltage after reaching a frequency limit such as the 148 kHz limit when less power is requested. The Buck regulator can accommodate the normal power transfer case by supplying a fixed voltage and the Tx will adjust the frequency to handle power change requests (may use a BUCK, BUCK/BOOST, or BUCK with pass-through voltage mode). Once the upper frequency limit is reached, change requests with BUCK output voltage changes are implemented by controlling the BUCK output by any number of ways (such as I2C or other digital communication method, or summing node into the Feedback pin) after the operating frequency reaches the frequency limit.

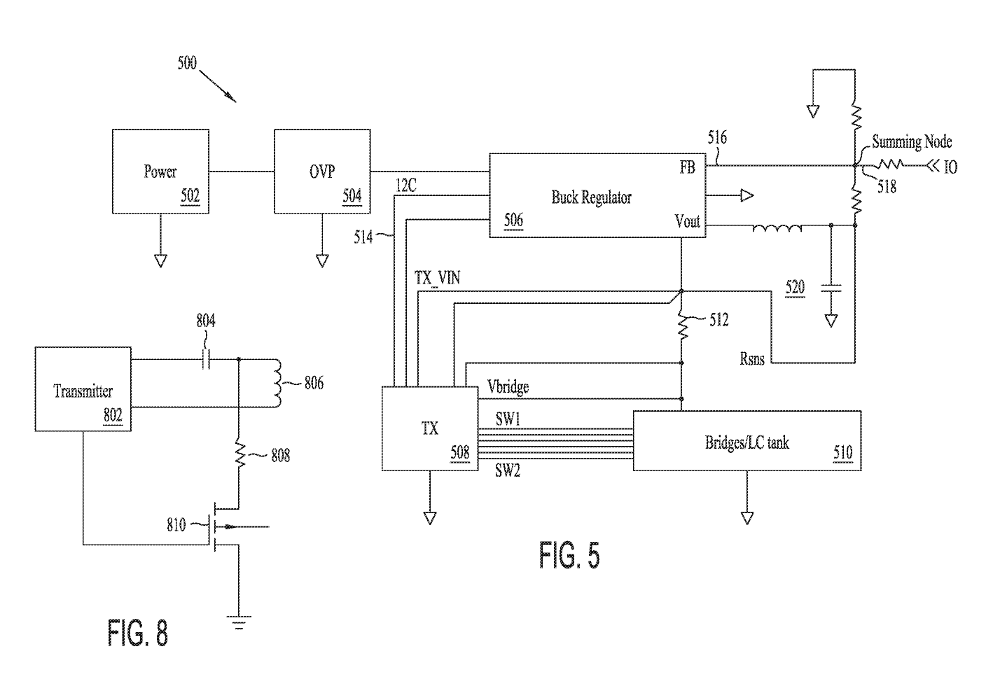

FIG. 5 illustrates a transmitter 500 that uses a buck regulator 506. As illustrated in FIG. 5, a power supply 502 can provide power to buck regulator 506 through an over-voltage protection circuit 504. The voltage supplied to buck regulator 506 from power supply 502 can be a standard voltage level, for example 5, 9, or 12 V. Buck regulator 506 can be a programmable buck regulator that outputs voltages Vout in a range of voltages, for example from 3.5V to 12V. As is illustrated, buck regulator 506 drives inductor/capacitor circuit 520 and a summing node 518 coupled between the intersection of the inductor and capacitor of circuit 520 and ground. Buck regulator 506 receives instructions from communications signal lines 514, for example I2C lines, or by adding a summing function into the feedback node (by injecting or extracting current from said feedback or summing node (FB)) 516 at summing node 518.

As is further illustrated in FIG. 5, the output voltage from buck regulator 506 is provided to the input voltage of a transmit circuit 508 or could provide power only to the Bridges/LC tank(s) 510. Transmit circuit 508 supplies the switching signals SW1 and SW2 and the bridge voltage level Vbridge to the bridges/LC tank circuit 510, which includes the transmit coil and switching transistors to drive the transmit coil 106. A sensor resistor 512 may be placed between the output voltage Vout of buck regulator 506 and the bridge voltage Vbridge supplied by transmit circuit 508 (high-side sensing) or between the Bridge Ground (BRIDGE GND) reference (0V) level and the rest of the circuitry on the printed circuit GND reference level (low-side sensing). The sensing signal may be used to control buck regulator 506, or detect input current consumed by the Tx during wireless power transfer for foreign-object-detection (FOD) or Over-current protection.

When less power is requested, for example when the receiver requests less power, and the frequency is at or close to the frequency limit, buck voltage regulator 506 can reduce the voltage output Vout to transmit circuit 508, which in turn affects the voltage Vbridge that is used to drive the bridges to the LC tank circuit. The bridge voltage Vbridge can be reduced while the duty cycle remains at 50%. The technique illustrated in FIG. 5 is expected to reduce EMI by eliminating <50% duty cycle operation of transmitter circuit 508. This circuit can Address RE (Radiated Emissions) by slew rate control, fixed common mode voltage level of LC resonance tank, and reduction of harmonic energy within the LC resonance tank.

### 3. Alteration to the Tank Resonance

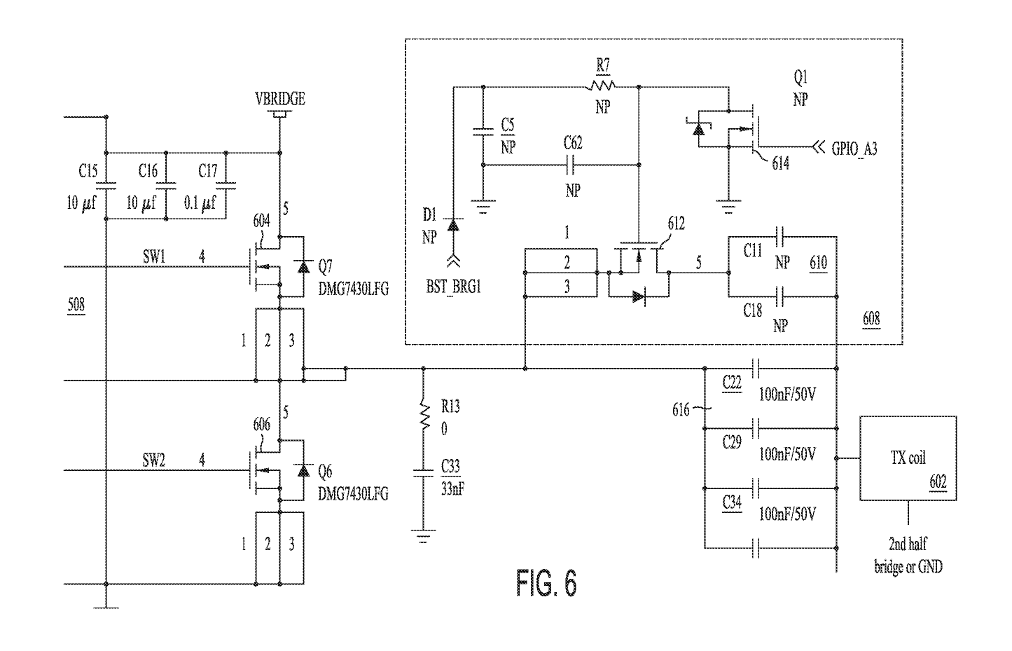

FIG. 6 illustrates an embodiment that can also reduce power transmission in a wireless power transmitter. As illustrated in FIG. 6, transmitter chip 508 provide switching signals SW1 and SW2 to the bridge formed by serially coupled switching transistors 604 and 606. The node between switching transistors 604 and 606 are coupled through resonance capacitors 616 to the transmit coil 106 in LC tank circuit 602. In accordance with these embodiments, a switching circuit 608 can place capacitors 610 in parallel with primary resonance capacitors 616, which changes the resonance frequency of the tank circuit formed with LC tank 602.

Switching circuit 608 includes switching transistor 612 configured to couple capacitors 610 in parallel with capacitors 616. The gate of transistor is controlled through switch 614 by an IO input GPIO_A3 and signal BST_BRG1. When switch 614 is activated, switch 612 is open. In some embodiments, multiple switching circuits 608 can be employed to allow for further and more variably shifting of the resonant frequency. Such switching techniques can also be used to switch series inductors or inductances into the LC resonance tank which will also result in shifting of the resonance of the tank and changes in potential power levels for a given operating frequency.

Consequently, when operating at or near the frequency limit and the receiver requests less power, switching circuit 608 can be activated to change the transmission resonance frequency to a lower value in order to reduce the power while maintaining a 50% duty cycle. Such a reduction of power can be accomplished over a wide range of coupling and load values.

As before, this approach is expected to reduce EMI by eliminating operation at <50% duty cycle. Further, RE can be further regulated by slew rate control, fixed common mode voltage level of LC resonance tank, and reduction of harmonic energy within the LC resonance tank.

### 4. Addition of Pulse Skipping

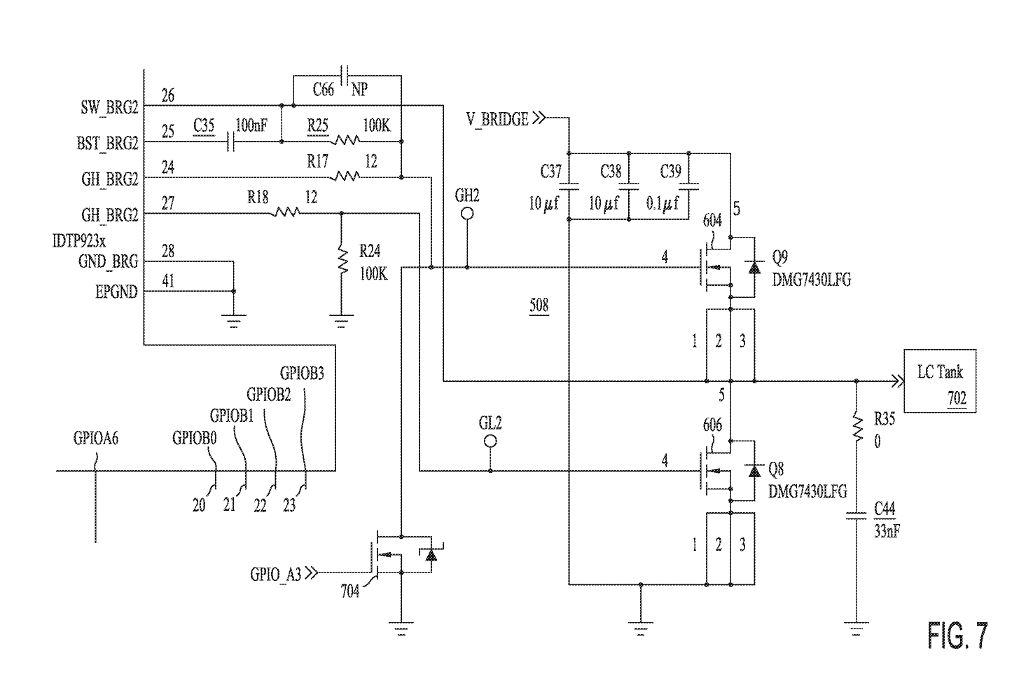

FIG. 7 illustrates an embodiment where a pulse skipping circuit is used to reduce power. As show in FIG. 7, a transistor 704 couples the gate of the high bridge transistor 604 to ground. Consequently, in response to the input signal GPIO. . . A3, the gate of switching transistor 604 can be intermittently coupled to ground, reducing the power supplied to LC Tank circuit 702, which includes transmit coil 106. Consequently, the high transistor gate 604 voltage is blocked periodically and increasing in duration to limit Tx power capabilities when operating at or near the frequency limit and the receiver requests less power. Again, the transmitter can continue to operate in a 50% duty cycle regime while the transmitted output power is reduced.

### 5. Programmable Load

FIG. 8 illustrates an embodiment where a programmable load impedance can be used to lower the transmitted power. As illustrated in FIG. 8, a transmitter 802 is coupled to a tank circuit formed from serially coupled capacitor 804 and transmit coil 806. As is further illustrated, transmitter 802 can turn a transistor 810 on in order to couple a resistance 808 between the node between capacitor 804 and transmit coil 806 and ground. As such, when operating at or close to the frequency limit and the receiver requests less power, energy can be removed from the tank circuit by modulating a load such as resistance 808. Again, such a circuit allows for the transmitter to operate in a 50% duty cycle while the transmit power is being reduced.

The above detailed description is provided to illustrate specific embodiments of the present invention and is not intended to be limiting. Numerous variations and modifications within the scope of the present invention are possible. The present invention is set forth in the following claims.

What is claimed is:

1. A method of reducing transmitted power in a wireless power transmitter, comprising:
reducing a resonance power level in a tank circuit coupled to a transmitter in the wireless power transmitter.

2. The method of claim 1, wherein an operating frequency is not increased above a frequency limit.

3. The method of claim 1, wherein reducing a resonance power level includes reducing a bridge voltage to a switching bridge coupled to the tank circuit with a buck regulator.

4. The method of claim 1, wherein reducing a resonance power level includes adjusting a resonance of the tank circuit.

5. The method of claim 1, wherein reducing a resonance power level includes providing a pulse skipping circuit to bridge switches that drive the tank circuit.

6. The method of claim 1, wherein reducing a resonance power level includes providing a programmable load to the tank circuit.

7. The method of claim 1, wherein a transmit coil is shielded.

8. A transmitter, comprising:
a wireless power transmitter;
a transmit coil coupled to the wireless power transmitter;
a power source coupled to the wireless power transmitter; and
a power limiter coupled to the wireless power transmitter that limits wireless power output.

9. The transmitter of claim 8, wherein the power limiter includes a shield positioned relative to the transmit coil.

10. The transmitter of claim 8, wherein the wireless power transmitter and the power limiter comprise:
a buck regulator; and
a transmit circuit coupled to the buck regulator and configured to drive a bridge circuit to drive the transmit coil,
wherein the transmit circuit controls the buck regulator to provide power to the bridge circuit to control power output from the transmit coil.

11. The transmitter of claim 8, wherein the wireless power transmitter comprises a switching circuit coupled through a capacitive network to the transmit coil and wherein the power limiter comprises
a switched capacitance to switch one or more capacitors across the capacitive network,
wherein the switched capacitance is controlled to reduce power output of the transmitter.

12. The transmitter of claim 8,
wherein the wireless power transmitter comprises a switching circuit coupled to the transmit coil, the switching circuit including a high transistor coupled in series with a low transistor,
wherein the power limiter includes a switched transistor coupled between a gate of the high transistor and ground, and
wherein the switched transistor is controlled to limit transmitted power.

13. The transmitter of claim 8, wherein the power limiter is a variable load coupled to the transmit coil and is controlled by the wireless power transmitter.

14. A transmitter, comprising:
a transmit coil;
means for driving the transmit coil; and
means for limiting power.
